(19) United States
(12) Patent Application Publication
(10) Pub. No.: US 2006/0056018 A1
(43) Pub. Date: Mar. 16, 2006

(54) Illumination apparatus for optical system

(75) Inventor: Frank Sieckmann, Bochum (DE)

Correspondence Address: HOUSTON ELISEEVA, 4 MILITIA DRIVE, SUITE 4, LEXINGTON, MA, 02421, US

(73) Assignee: Leica Microsystems CMS GmbH, Wetzlar (DE)

(21) Appl. No.: 11/225,810

(22) Filed: Sep. 13, 2005

(30) Foreign Application Priority Data
Sep. 13, 2004 (DE) 10 2004 044 628.8

(51) Int. Cl. G02B 21/06

(52) U.S. Cl. 359/385

(57) ABSTRACT

An illumination apparatus for an optical system, in particular for a microscope, having a light source (2) emitting preferably broad-band light in order to furnish an output light beam (3), and having a filter device (5), is characterized, in the interest of economical, low-maintenance, and vibration-free generation of an illuminating light beam encompassing multiple wavelengths or wavelength regions, and a high degree of flexibility in terms of the spectral light shaping of the illuminating light beam, in that the filter device (5) encompasses at least one means (7) for spatial splitting of the output light beam (3) into light sub-beams (8, 9) and at least one means for spectral manipulation of at least one of the light sub-beams (8, 9); and that at least one beam combining means is provided with which definable light sub-beams (9) are combinable into one illuminating light beam (14) for the optical system.

### RELATED APPLICATIONS

This application claims priority to German patent application number 10 2004 044 628.8, filed Sep. 13, 2004, which is incorporated herein by reference in its entirety.

### FIELD OF THE INVENTION

The invention concerns an illumination apparatus for an optical system, in particular for a microscope, having a light source emitting preferably broad-band light in order to furnish an output light beam, and having a filter device.

### BACKGROUND OF THE INVENTION

Illumination apparatuses for optical systems, in particular for microscopes, are known in a wide variety of different embodiments. A fundamental distinction can be made in this context between illumination apparatuses with which a monochromatic illuminating light beam is furnished to the optical system, and illumination apparatuses that allow the spectral light shaping of the illuminating light beam to be influenced, and allow an illuminating light beam having multiple definable wavelengths or wavelength regions to be generated.

The known technical methods for influencing the light color of an illuminating light beam in controlled fashion include, for example, the use of filters, with which a narrow wavelength region can be picked out of a broad-band light spectrum. Filters are, however, inflexible with regard to spectral light shaping, and moreover are expensive to manufacture.

In order to cut out of a broad-band light beam a narrow-band wavelength region that can then be delivered to an optical instrument, monochromators are often used as an alternative to filters. The broad-band light beam is generally parallelized through a collimation optic and spectrally subdivided by means of a prism or a diffraction grating. The desired portion of the spectrum is imaged onto an exit slit by means of an additional optic. The wavelength that is picked out can be modified by rotating the prism or displacing the diffraction grating. Monochromators are disadvantageous in particular because they are unwieldy and difficult to align, demanding a high level of experience on the part of the user. A further disadvantage is that monochromators operate relatively slowly, so that a rapid change in the spectral composition of the illuminating light beam that is generated is generally not possible.

Additionally known from practical use as a way of furnishing an illuminating light beam encompassing multiple definable spectral regions is the use of multiple separate light sources, which are combined by means of a beam splitter module into a single beam path. The individual light sources are switched as a function of the desired wavelengths and/or wavelength regions. A critical disadvantage of this kind of illumination apparatus is that multiple light sources are necessary, resulting in increased costs for the illumination apparatus.

In many investigative methods, for example including camera-assisted fluorescence microscopy, experiments are generally carried out using only two wavelengths. Ratio imaging or ion imaging may be mentioned merely by way of example. In this context, the wavelengths are generally switched over with the aid of a mechanism, resulting in troublesome vibrations, increased wear, and similar negative effects. The vibrations can have a direct disadvantageous influence on the quality of the later analysis of the microscopic images that are obtained. A further disadvantage may be seen the fact that switching between the wavelengths requires a certain amount of time. Many highly time-critical experiments are therefore possible only with great effort and with the use of vibration-free mechanical rapid switchers, making such experiments costly.

### SUMMARY OF THE INVENTION

It is thus the object of the present invention to describe an illumination apparatus for an optical system of the kind cited initially which makes possible economical, low-maintenance, and vibration-free generation of an illuminating light beam encompassing multiple wavelengths or wavelength regions, and in which at the same time a high degree of flexibility exists in terms of the spectral light shaping of the illuminating light beam by a user.

The aforesaid object is achieved, according to the present invention, by the features of claim 1. According to the latter, the illumination apparatus in question is characterized in that the filter device encompasses at least one means for spatial splitting of the output light beam into light sub-beams and at least one means for spectral manipulation of at least one of the light sub-beams; and that at least one beam combining means is provided with which definable light sub-beams are combinable into one illuminating light beam for the optical system.

What has been recognized according to the present invention is firstly that a simultaneous illumination of a specimen with multiple wavelengths can be achieved by the fact that, proceeding from a broad-band light source, a filter device is provided which encompasses means with which the broad-band output light beam is splittable into light sub-beams. According to the present invention, the light sub-beams that are generated are manipulated in terms of their spectral composition using appropriate means, and then combined by means of a beam combining means into one illuminating light beam. The latter is then deliverable to the optical system in order to achieve there, for example in a biological specimen, fluorescent excitations of various fluorochromes by simultaneous illumination with multiple wavelengths.

What is created with the illumination apparatus according to the present invention is thus a cost-effective system which requires only a single light source and in which no moving mechanical parts are present while an experiment is running, so that troublesome vibrations are effectively eliminated. The illumination apparatus according to the present invention is further characterized by its versatile applicability. For example, the apparatus can advantageously be used in conventional light microscopy or fluorescence microscopy, and for different types of illumination (transmitted light, incident light). The apparatus can moreover be used for optical investigations in a wide variety of disciplines; optical-light experiments in the fields of biology, genetics, or materials research may be mentioned here merely by way of example. A universal light source is thus created as the result of the apparatus according to the present invention.

In the interest of good user-friendliness, the light source, the means for spatial splitting of the output light beam, the means for spectral manipulation of the light sub-beams, and the beam combining means can be arranged in a housing along the lines of a lamp housing. The lamp housing can be selected by the user in accordance with his or her specific requirements, and easily installed on the optical instrument.

In the context of concrete embodiments, the means for spatial splitting of the output light beam can be embodied as semitransparent mirrors, dichroic beam splitters, band boundary filters, single-line notch filters, or the like. Concretely, for example, semitransparent mirrors can be provided which direct 50% of the incident light intensity of the output light beam into the reflected light sub-beam, and the other 50% of the light intensity into the light sub-beam passing through the mirror. When band boundary filters are used, it is possible to exploit the fact that the filters possess, for example, substantially transmissive properties for wavelengths above their band boundary and substantially reflective properties for wavelengths below their band boundary. With a single-line notch filter, almost 100% of the light of one wavelength can be reflected into one light sub-beam, while the remainder of the longer-wavelength light is allowed to pass through into a second light sub-beam.

The means for spectral manipulation of the light sub-beams are preferably embodied as spectral filters. Both the means for spatial splitting of the output light beam and the means for spectral manipulation of the light sub-beams can advantageously be integrated into a filter cube. For example, a dichroic beam splitter can be arranged diagonally in the interior of the cube, and the light exit surfaces of the filter cube can be embodied as spectral filters for certain wavelengths.

To implement a further division of the output light beam into multiple light sub-beams of different spectral compositions, multiple filter cubes can be arranged in cascade fashion one behind another. The cascade is advantageously arranged on the optical axis of the output light beam, so that additional optical components, such as deflection mirrors or the like, can be dispensed with.

In order to combine two light sub-beams, the beam combining means could encompass a semitransparent mirror. In particular, the beam combining means can also be embodied as a light combining cube, in which context the semitransparent mirror could constitute one diagonal of the cube.

In the context of a preferred embodiment, a cascade of light-combining cubes that are preferably arranged parallel to the cascade of filter cubes is provided. In particularly advantageous fashion, the means for spatial splitting of the output light beam are designed in such a way that one of the two light sub-beams that are generated extends orthogonally to the output light beam, and the other light sub-beam collinearly with the output light beam. It is then thereby possible for one filter cube and one light combining cube to be respectively associated in paired fashion with one another.

With regard to easily operability and flexible adaptation, interchangeability of both the filter cubes and the light combining cubes can be provided for. In particular, interchangeability based on the known insertion technique can be provided, in which the cubes are inserted into the beam path and can be snapped into place there in a predefined position. In the interest of a higher degree of automation, the cubes can moreover be interchangeable with the aid of a motorized device.

The output light beam is preferably coupled into the filter device, i.e. more precisely into the first filter cube of the cascade, by means of an optic downstream from the light source, which optic is embodied in the simplest case as a converging lens.

It proves advantageous to use a halogen lamp or a gas discharge lamp in order to furnish a homogeneous broad-band spectrum in the output light beam. When selecting the light source, it should be ensured in any event that those wavelengths or wavelength regions that are to be selected for the illuminating light beam are present with sufficient intensity in the emission spectrum of the light source.

To ensure that the illuminating light beam that is generated can be delivered to the optical system, an optic for coupling out the illuminating light beam can be provided, with which optic the illuminating light beam can be imaged, for example, onto the entrance pupil of the downstream optical system.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

There are various ways of advantageously embodying and refining the teaching of the present invention. The reader is referred, for that purpose, on the one hand to the claims subordinate to claim 1, and on the other hand to the explanation below of a preferred exemplifying embodiment of the invention with reference to the drawings. In conjunction with the explanation of the preferred exemplifying embodiment of the invention with reference to the drawings, an explanation is also given of generally preferred embodiments and refinements of the teaching. In the drawings:

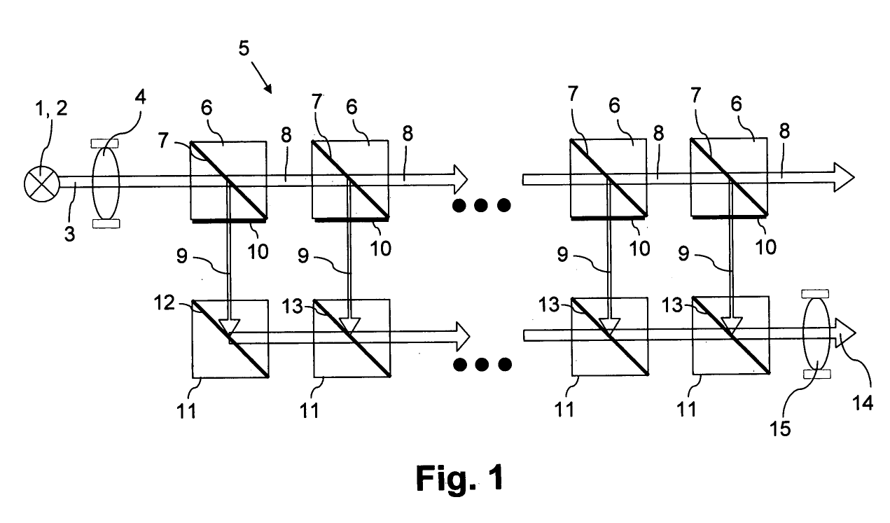

The single FIG. 1 schematically depicts an exemplifying embodiment of an illumination apparatus according to the present invention for an optical system.

### DETAILED DESCRIPTION OF THE PREFERRED EMBODIMENTS

The illumination apparatus encompasses a light source 2, embodied as a gas discharge lamp 1, with which an output light beam 3 encompassing a broad spectral region is furnished. Output light beam 3 is imaged with an imaging optic 4 onto a filter device 5.

Filter device 5 encompasses a first cascade of filter cubes 6 that are arranged one behind another on the beam axis of output light beam 3. In the interior of each filter cube 6, means 7 for spatially splitting the incident light beam are arranged at a 45° angle to the axis of output light beam 3. A light sub-beam 8 extending collinearly with output light beam 3, as well as a light sub-beam 9 extending orthogonally to output light beam 3, are therefore generated in each filter cube 6. The splitting into light sub-beams 8 and 9 can be carried out in wavelength-independent fashion, for example for the case in which means 7 for spatial splitting are embodied as semitransparent mirrors. Alternatively, spectral light shaping can also be performed already in the context of the splitting into light sub-beams 8 and 9, by the fact that, for example, band boundary filters are provided as means 7 for spatial splitting. A further controlled spectral light shaping of light sub-beams 9 is achieved by the fact that spectral filters 10 are arranged at the light exit surfaces through which light sub-beams 9 emerge from filter cubes 6. For specific applications, it may be advantageous also to provide filters at the light exit surfaces through which light sub-beams 8 emerge from filter cubes 6.

Light sub-beams 9 that are blocked out of output light beam 3, which encompass those wavelengths with which an optical system (not shown) is to be illuminated, strike light combining cubes 11, which are likewise arranged in cascade fashion. Each light combining cube 11 corresponds to one filter cube 6.

Whereas the first light combining cube 11 encompasses only a deflection mirror 12, a semitransparent mirror 13, with which light sub-beams 9 are combined together, is integrated into each of the downstream light combining cubes 11. Illuminating light beam 14 generated in this fashion is imaged by means of an imaging optic 15 onto the entrance pupil of the downstream optical system.

The three dots indicate that the cascades can be arbitrarily cascaded using additional filter cubes 6 and light combining cubes 11. In other words, cubes 6, 11 can thus be selected by the user in accordance with specific requirements, and introduced into the beam path using the known insertion technique. The interchangeability of cubes 6, 11 makes it possible to influence the spectral composition of illuminating light beam 14 in almost any desired way.

In conclusion, let it be emphasized very particularly that the exemplifying embodiment above, selected in entirely random fashion, serves merely for discussion of the teaching according to the present invention but does not limit it to this exemplifying embodiment.

Parts List

1: Gas discharge lamp. 2: Light source. 3: Output light beam. 4: Imaging optic. 5: Filter device. 6: Filter cube. 7: Means for spatial splitting. 8: Collinear light sub-beam. 9: Orthogonal light sub-beam. 10: Spectral filter. 11: Light combining cube. 12: Deflection mirror. 13: Semitransparent mirror. 14: Illuminating light beam. 15: Imaging optic

What is claimed is:

1. An illumination apparatus for an optical system, in particular for a microscope, having a light source (2) emitting preferably broad-band light in order to furnish an output light beam (3), and having a filter device (5),
wherein the filter device (5) encompasses at least one means (7) for spatial splitting of the output light beam (3) into light sub-beams (8, 9) and at least one means for spectral manipulation of at least one of the light sub-beams (8, 9); and at least one beam combining means is provided with which definable light sub-beams (9) are combinable into one illuminating light beam (14) for the optical system.

2. The illumination apparatus according to claim 1, wherein the light source (2), the means (7) for spatial splitting of the output light beam (3), the means for spectral manipulation of the light sub-beams (8, 9), and the beam combining means are arranged in a housing along the lines of a lamp housing.

3. The illumination apparatus according to claim 1, wherein the means (7) for spatial splitting of the output light beam (3) are embodied as semitransparent mirrors, dichroic beam splitters, band boundary filters, single-line notch filters, or the like.

4. The illumination apparatus according to claim 1, wherein the means for spectral manipulation of the light sub-beams (8, 9) are embodied as spectral filters (10).

5. The illumination apparatus according to claim 1, wherein the means (7) for spatial splitting of the output light beam (3) and the means for spectral manipulation of the light sub-beams (8, 9) are integrated into a filter cube (6).

6. The illumination apparatus according to claim 5, wherein multiple filter cubes (6) are arranged in cascade fashion one behind another.

7. The illumination apparatus according to claim 6, wherein the cascade is placed on the optical axis of the output light beam (3).

8. The illumination apparatus according to claim 1, wherein the beam combining means encompass a semitransparent mirror (13).

9. The illumination apparatus according to claim 1, wherein the beam combining means are embodied as light combining cubes (11).

10. The illumination apparatus according to claim 6, wherein a cascade of light-combining cubes (11) is constituted parallel to the cascade of filter cubes (6).

11. The illumination apparatus according to claim 1, wherein the means (7) for spatial splitting of the output light beam (3) are designed to generate light sub-beams (9) extending orthogonally to the output light beam (3).

12. The illumination apparatus according to claim 5, wherein a corresponding light combining cube (11) is associated with each filter cube (6).

13. The illumination apparatus according to claim 5, wherein the filter cubes (6) and/or the light combining cubes (11) are interchangeable.

14. The illumination apparatus according to claim 5, characterized by a motorized device for interchanging the filter cubes (6) and/or the light combining cubes (11).

15. The illumination apparatus according to claim 1, wherein the light source (2) is followed by an optic (4) for coupling the output light beam (3) into the filter device (5).

16. The illumination apparatus according to claim 1, wherein the light source (2) is a halogen lamp, a gas discharge lamp (1), or the like.

17. The illumination apparatus according to claim 1, characterized by an optic (15) for coupling out the illuminating light beam (14).
